(19) United States
(12) Patent Application Publication
(10) Pub. No.: US 2010/0045851 A1
(43) Pub. Date: Feb. 25, 2010

(54) Method of controlling mechanical shutter

(75) Inventors: Eugene Savastyuk, Suwon (KR); Yeong Hyo Jeong, Suwon (KR); Won Tae Choi, Gyunggi-do (KR); Keun Woo Park, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/461,674

(22) Filed: Aug. 20, 2009

(30) Foreign Application Priority Data
Aug. 21, 2008 (KR) 10-2008-0081879

(51) Int. Cl. H04N 5/235; G03B 9/08

(52) U.S. Cl. 348/362; 348/E05.037; 396/452

(57) ABSTRACT

There is provided a method of controlling a mechanical shutter that can ensure faster shutter speed by preventing a reduction of the shutter speed of the mechanical shutter caused by signal loss and physical loss caused by inertia. A method of controlling a mechanical shutter according to an aspect of the invention may include performing a row reset operation to remove image information remaining in an image sensor according to input of a trigger event generated by a user to acquire an image; transmitting a shutter close operation start signal for a mechanical shutter to the mechanical shutter before the row reset operation ends after a predetermined delay time from a time when the row reset operation starts; exposing the imager sensor right after the row reset operation ends; and fully closing the mechanical shutter.

### CROSS-REFERENCE TO RELATED APPLICATIONS

This application claims the priority of Korean Patent Application No. 2008-0081879 filed on Aug. 21, 2008, in the Korean Intellectual Property Office, the disclosure of which is incorporated herein by reference.

### BACKGROUND OF THE INVENTION

1. Field of the Invention

The present invention relates to a method of controlling a mechanical shutter, and more particularly, to a method of controlling a mechanical shutter that can ensure faster shutter speed by preventing a reduction of the shutter speed of the mechanical shutter caused by signal loss and physical loss caused by inertia.

2. Description of the Related Art

In general, mechanical shutters have been increasingly applied to digital camera modules disposed in mobile apparatuses to narrow the gap between general digital still cameras and the embedded digital camera modules.

The mechanical shutter is limited in terms of exposure time. That is, the shutter speed is limited due to characteristics of the mechanical shutter that is driven by a step motor and the like.

When an image is captured by using a digital camera or the like, the image may be captured in various situations ranging from very dark conditions (for example, outdoors at night) to very bright conditions (for example, in bright daylight). In the very bright conditions, it may be impossible for the camera to ensure sufficient exposure for a subject due to the limitations of the mechanical shutter or the iris. For example, since the maximum speed (ensuring the shortest exposure time) is limited, the image captured by the camera using the mechanical shutter in a very bright scene is excessively bright with undesirable saturation due to overexposure despite the maximum shutter speed.

Particularly, the mechanical shutter causes unnecessary delays, such as a delay when signals are exchanged in a circuit to control the operation of the mechanical shutter, a delay when a voltage is excited, a delay when a motor for driving the shutter is accelerated, and a delay when the shutter closes. Thus, it is difficult to ensure faster shutter speed of the mechanical shutter.

Therefore, there has been a need for a method of controlling shutter speed that can reduce the influence of the unnecessary delays during the operation of the mechanical shutter, and at the same time, provide very short exposure time for an image sensor.

### SUMMARY OF THE INVENTION

An aspect of the present invention provides a method of controlling a mechanical shutter that can reduce the influence caused by unnecessary delays during the operation of a mechanical shutter inside a camera module and provide very short exposure time for an image sensor.

According to an aspect of the present invention, there is provided a method of controlling a mechanical shutter, the method comprising: performing a row reset operation to remove image information remaining in an image sensor according to input of a trigger event generated by a user to acquire an image; transmitting a shutter close operation start signal for a mechanical shutter to the mechanical shutter before the row reset operation ends after a predetermined delay time from a time when the row reset operation starts; exposing the imager sensor right after the row reset operation ends; and fully closing the mechanical shutter.

The exposing the image sensor may be initiated while the close operation of the mechanical shutter is in progress.

The length of the predetermined delay time may be controlled to adjust a time at which the exposing of the image sensor is initiated.

The method may further include: reading out charges accumulated in the image sensor and storing the read charges while exposing the image sensor; opening the mechanical shutter after storing the read charges ends; and returning to a preview mode after the mechanical shutter is opened.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating an example of a camera system to which a method of manufacturing a mechanical suffer is applied according to an exemplary embodiment of the present invention; and

FIG. 2 is a timing chart illustrating a method of manufacturing a mechanical shutter according to an exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

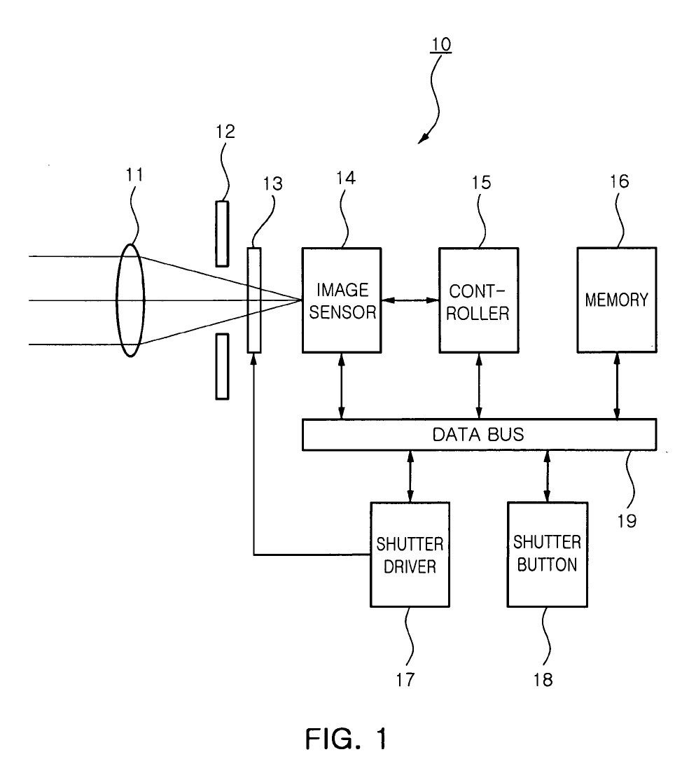

FIG. 1 is a view illustrating an example of a camera system to which a method of controlling a mechanical shutter is applied according to an exemplary embodiment of the invention.

As shown in FIG. 1, a camera system to which a mechanical shutter according to an exemplary embodiment of the invention is applied may include an image sensor 11, a lens 12 disposed in front of a light receiving surface of the image sensor 11, an iris 13, a mechanical shutter 14, a controller 15 controlling the operation of the image sensor 11 and the mechanical shutter 14, a memory 16, a shutter driver 17 sending an instruction to a mechanical shutter driving unit (not shown), such as a step motor, instructing the mechanical shutter driving unit to operate to drive the mechanical shutter, and a shutter button 18 receiving a trigger event to acquire an image from a user. The image sensor 11, the controller 15, the memory 16, the shutter driver 17, and the shutter button 18 can transmit and receive necessary signals between each other by using a data bus 19.

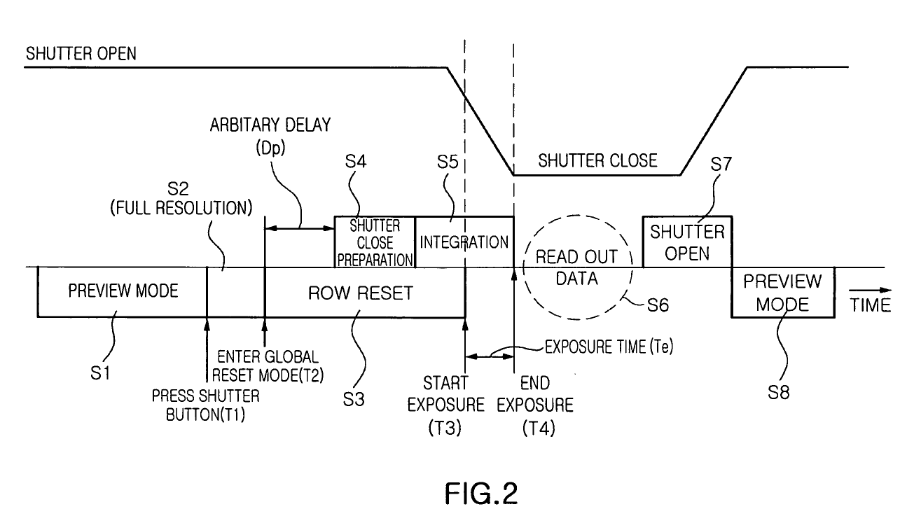

FIG. 2 is a timing chart illustrating a method of controlling a mechanical shutter according to an exemplary embodiment of the invention. An opened or closed state of the mechanical shutter over time is shown by a solid line in the upper part of FIG. 2. Operations of controlling the image sensor and the mechanical shutter over time are shown in the lower part of FIG. 2.

Hereinafter, the operation and effect of the method of controlling a mechanical shutter according to the exemplary embodiment of the invention will be described in detail with references to FIGS. 1 and 2.

First, the camera system 10, such as a general digital still camera or a camera module of a mobile device, may be in a preview mode S1 that allows a user to check composition and brightness of a scene before acquiring a desired image. In the preview mode S1, the mechanical shutter 14 may be already opened. The image sensor 11 that is exposed since the mechanical shutter 14 is opened may activate minimum pixel arrays required to generate a preview, generate a preview image, and display the generated preview image by using a display unit (not shown).

Then, after the user determines an image to be acquired through the preview mode, the user presses the shutter button 18 at a time T1 or generates a trigger event informing the determination to acquire an image by using another unit. The trigger event generated by the user is input to the controller 15. Then, the controller 15 activates the entire pixel arrays included in the image sensor 11 to acquire an entire image having the maximum resolution that is supported by the image sensor 11 (S2).

Then, the camera system 10 enters a global reset mode to operate the mechanical shutter 14 at a time T2. The controller 15 resets the entire pixel array area of the image sensor 11 at the same time when the camera system 10 enters the global reset mode. Therefore, the preview mode S1 in progress or image information remaining in the image sensor 11 by the received light during the previous process of acquiring the image can be removed. When the image sensor 11 is a CMOS, the pixel array area may be reset in units of pixel-rows. The entire pixels of the image sensor 11 are reset after the global reset mode is initiated, which is referred to as a row reset operation S3.

While the row reset operation S3 with respect to the image sensor 11 is being performed, a preparation operation S4 to close the mechanical shutter is performed. The shutter close preparation operation S4 is initiated as the controller 15 generates a shutter closing operation start signal and transmits the shutter closing operation start signal to the mechanical shutter. For example, the shutter close preparation operation S4 may include a delay occurring when the controller 15 outputs the shutter closing operation start signal for driving the mechanical shutter 14, and the shutter driver 17 loads the shutter closing operation start signal, and a delay occurring when a driving voltage used to drive a step motor for the operation of the mechanical shutter is excited. Further, the preparation operation S4 may also include an acceleration delay occurring when the step motor changes from a pause state to a rotary state, and a delay caused by inertia when the step motor starts to move from the pause state in order to perform the closing operation of the shutter. To this end, the controller 15 transmits the closing operation start signal to the mechanical shutter 14 (to the shutter driver 17 in the embodiment illustrated in FIG. 1).

After the shutter close preparation operation S4 is completed, an integration operation S5 where the image sensor can be exposed to acquire an image is performed during a time duration when the mechanical shutter 14 changes from an open state to a close state.

When the shutter close preparation operation S4 is completed during the row reset operation S3, the closing operation of the mechanical shutter 14 may start before the row reset operation S3 is completed, that is, before the image sensor 11 is exposed to acquire an image. At a time T3 when the row reset operation S3 is completed, the image sensor 11 may start to be exposed. At a time T4 when the mechanical shutter 14 is fully closed, the exposure of the image sensor 11 may end. Therefore, in this embodiment, the image sensor 11 may be exposed to acquire an image while the mechanical shutter changes from a full open state to a full closed state.

In order to appropriately determine the exposure time of the image sensor 11, the shutter close preparation operation S4 may start after an arbitrary delay (Dp) from the initiation of the row reset operation S3. Since the time required for the row reset operation S3 of the image sensor 11 and the time required for the shutter close preparation operation S4 can be kept constant, exposure time Te during which the image sensor 11 is exposed to acquire an image can be appropriately adjusted by accurately controlling the arbitrary delay (Dp).

Then, when the mechanical shutter 14 becomes in the full closed state, the global reset mode is terminated, and an image sensor reading operation (S6) starts to read out charges accumulated in the image sensor 11. When the image sensor reading operation (S6) is completed, a shutter open instruction is transmitted from the controller 15 to the shutter driver 17. Like the shutter closing operation, the shutter opening operation is initiated after an electrical delay and a mechanical delay time caused by inertia (S7). After the shutter opening operation is completed, the image sensor 11 may enter a preview mode (S8) again.

As set forth above, according to exemplary embodiments of the invention, since the operation of a mechanical shutter stats while a row reset operation of an image sensor is performed, a reduction in shutter speed caused by unnecessary but unavoidable delay during the row reset operation when driving the mechanical shutter can be prevented.

Further, by exposing the image sensor while the shutter is closing, exposure time of the image sensor is significantly reduced to thereby acquire an image with appropriate exposure even under very bright condition.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of controlling a mechanical shutter, the method comprising:
performing a row reset operation to remove image information remaining in an image sensor according to input of a trigger event generated by a user to acquire an image;
transmitting a shutter close operation start signal for a mechanical shutter to the mechanical shutter before the row reset operation ends after a predetermined delay time from a time when the row reset operation starts;
exposing the imager sensor right after the row reset operation ends; and
fully closing the mechanical shutter.

2. The method of claim 1, wherein the exposing the image sensor is initiated while the close operation of the mechanical shutter is in progress.

3. The method of claim 1, wherein the length of the predetermined delay time is controlled to adjust a time at which the exposing of the image sensor is initiated.

4. The method of claim 1, further comprising:
reading out charges accumulated in the image sensor and storing the read charges while exposing the image sensor;
opening the mechanical shutter after storing the read charges ends; and
returning to a preview mode after the mechanical shutter is opened.
